(19) United States
(12) Patent Application Publication
(10) Pub. No.: US 2025/0214820 A1
(43) Pub. Date: Jul. 3, 2025

(54) Vehicle Jack System and Method

(71) Applicant: Logan Henderson, Houston, TX (US)

(72) Inventor: Logan Henderson, Houston, TX (US)

(21) Appl. No.: 18/402,726

(22) Filed: Jan. 3, 2024

(51) Int. Cl. B66F 17/00; B66F 3/22; B66F 3/25; B66F 3/44

(52) U.S. Cl. CPC B66F 17/00; B66F 3/22; B66F 3/25; B66F 3/44

(57) ABSTRACT

An apparatus having a jack system coupled to a platform. The platform has a base section having an accelerometer tilt sensor, a pressure sensor, and a processor coupled to the accelerometer tilt sensor and the to the pressure sensor. A pillar section is integrally and adjacently coupled to the base section.

### BACKGROUND

Conventional vehicle jack systems often pose significant challenges and risks for individuals. These manual vehicle jack systems require considerable physical effort from the individual and can be unsafe when used on busy roads or uneven surfaces. Additionally, the manual operation of these vehicle jack systems can lead to imprecise lifting, potentially damaging the vehicle or causing accidents. Having an advanced auto jack system that addresses these issues is a challenge.

### BRIEF DESCRIPTION OF THE DRAWINGS

FIG. 1 is a perspective view of a jack system comprising a pantograph jack and a wireless mobile device.

FIG. 2 is a profile view of a pantograph jack system illustrating safety embodiments encased a platform of a pantograph jack system.

FIG. 3 is a perspective view of a jack system comprising a bottle jack and a wireless mobile device.

FIG. 4 is a profile view of a bottle jack system illustrating safety embodiments encased in a platform of a bottle jack system.

FIG. 5. is a perspective view of a pantograph jack system positioned under a mobile vehicle.

FIG. 6 is a flow chart of the method of using a jack system.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Modern vehicle jack systems may often pose significant challenges and safety risks for individuals. For example, individuals may be stranded in remote locations with limited lighting, uneven road surfaces, torrential weather events, or other unaware motorists. In addition, these modern vehicle jacks may require considerable physical effort from individuals and can be unsafe for those with limited mobility, limited physical ability, visual impairment, or limited mechanical prowess. These limitations could result in imprecise lifting which could potentially damage the vehicle, cause third-party accidents, or could result in the individual being injured themselves.

The embodiments disclosed herein provide such a solution. Specifically, the embodiments describe a vehicle jack system with various safety features that should mitigate such risk posed by modern vehicle jacks. For example, the vehicle jack system may include safety features such as maximum height restrictors to prevent overextension, potential flipping of the vehicle, or exceeding the jack's working conditions and payload capacity. The vehicle jack system strictly adheres to existing safety protocols and regulations set forth by automobile rules, regulations, and laws to ensure safe and reliable operation.

The vehicle jack system may be equipped with reflective stripes and glow-in-the-dark markings to enhance visibility during nighttime use or in low-light conditions, reducing the risk of accidents and ensuring safer operations on the road. The body of the vehicle jack system may be fitted with light-emitting diodes (i.e., LED) to provide additional illumination during operation, ensuring clear visibility, and further enhancing safety. Safety indicators are incorporated to indicate when the vehicle jack system is in a locked up or locked down position, providing users with visual cues for secure and accurate operation.

The vehicle jack system may be equipped with an overload protection system. If the weight capacity is exceeded by a vehicle, the vehicle jack system automatically shuts off the motor, preventing damage to the jack and ensuring user safety. Also, in the event of a power failure or technical issue, a manual override mechanism is incorporated, allowing users to operate the vehicle jack system manually for emergency situations.

The foot or bottom surface of the vehicle jack system is designed with a slip-resistant surface or rubberized pads to prevent the vehicle jack system from sliding or tipping during operation, providing additional stability. To meet the requirements of various vehicles, the vehicle jack system may come in different sizes to accommodate trucks, cars, and even recreational vehicles (i.e., RVs). Each size is engineered for optimal durability and height capacity, ensuring safe and efficient lifting, and lowering of vehicles of different sizes and weights. These along with other features are described below.

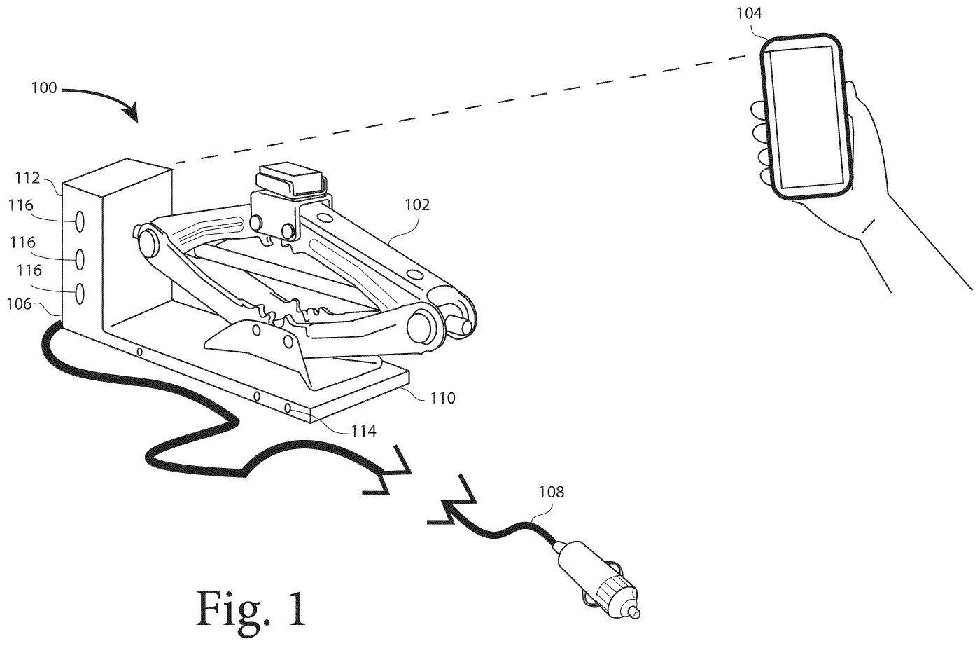

For example, FIG. 1 is a perspective view of a jack system comprising a pantograph jack and a wireless mobile device. As illustrated in FIG. 1, a jack system 100 may include a pantograph jack 102. Here, the pantograph jack 102 is similar to a modern pantograph jack in that it includes a pair of upper arms and a pair of lower arms pivotally connected to each other by a metal member and a nut member. Typically, a manually operated rod member is coupled to the arms by a bearing member and is used to physically operate the pantograph jack.

In one or more embodiments, the jack system 100 includes a mobile wireless device 104. The mobile wireless device 104 may include a standard smart phone device having installed an operating system for operating downloadable software applications for communicating with the jack system 100. The mobile wireless device 104 may also include a separate handheld device specifically designed and manufactured for use with the jack system 100. In one or more embodiments, the mobile wireless device 104 may be communicably coupled to the jack system 100 through short-wave wireless communication technology, such as BLUETOOH® (owned by BLUETOOH SIG, INC.) technology. Alternatively, the communicable handheld device may not be mobile or wireless, but rather a handheld device physically connected to the jack system 100 via an electrical cord. Further, the jack system 100 may come with a low-frequency detached remote control, similar to a small LED light strip remote, providing users with a user-friendly and intuitive interface. Illuminated up and down arrows on the remote allow for seamless direction control of the jack system 100; and lights on the remote indicate the jack system's 100 positioning, whether fully extended or compressed. This allows individuals to monitor the lifting process safely from a distance, eliminating the need to bend over or stand beside the vehicle during operation, thus enhancing user safety and convenience.

As illustrated in FIG. 1, the jack system 100 is coupled to a platform 106. As shown in FIG. 1, the platform 106 is the “L”-shaped section by which the pantograph jack is coupled to. The platform 106 is a hollow and sturdy enclosure that encases the electro-mechanical components for operating the jack system 100. Although not illustrated for clarity, the platform 106 includes support beams and other structures to help distribute the weight and tolerate the stress load created by the weight of a vehicle.

As further illustrated in FIG. 1, the jack system 100 may include a retractable power adaptor 108. More specifically, the platform 106 includes the retractable power adaptor 108. The retractable power adaptor 108 is the means by which power is transferred from a power source (i.e., direct current or alternating current) to the jack system 100. The power adaptor 108 may be retractable. That is, the power adaptor 108 may be pulled by an individual from the platform 106 to its length capacity, and once utilized automatically retracts back into the platform 106. This safety feature limits the need for an individual to physically recoil the power adaptor 108 after use. In one or more embodiments, the retractable power adaptor 108 includes an automobile auxiliary power outlet. In another embodiment, the retractable power adaptor 108 includes an electrical plug.

In one or more embodiments, the platform 106 may include a base section 110. The base section 110 of the platform 106 is the component that supports the jack mechanism (i.e., pantograph jack 102). That is, the base section 110 is the component of the jack system 100 that is placed on a surface of a ground for supporting a vehicle. The jack mechanism (i.e., pantograph jack 102) is coupled to the roof of the base section 110. In one or more embodiments, as illustrated in FIG. 1, the platform 106 includes a pillar section 112. The pillar section 112 may be adjacently positioned and integrally coupled to the base section 110. The pillar section 112 may be the vertically positioned component that is mechanically connected to the rod that operates the arms of the pantograph jack 102.

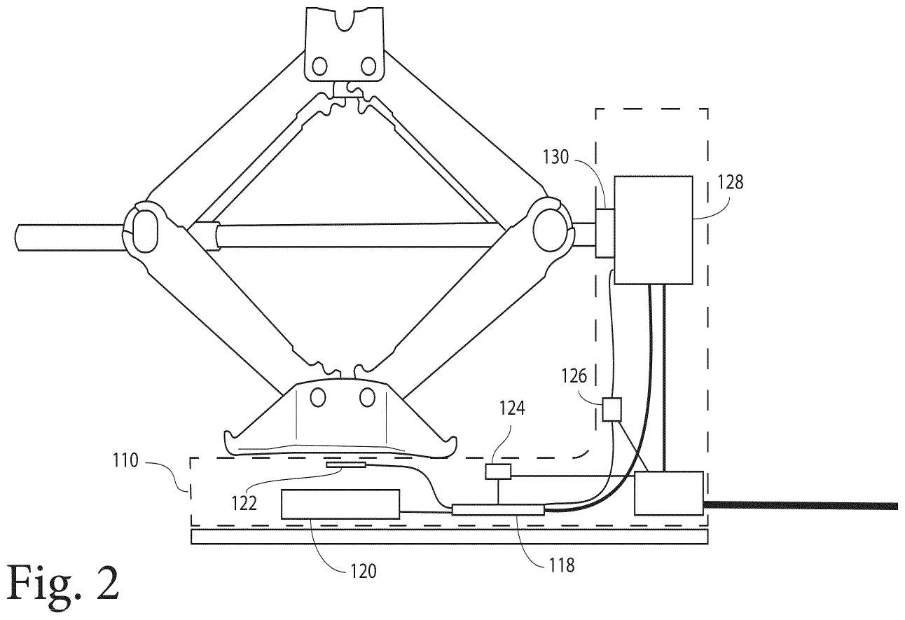

As illustrated in FIG. 1, the base section 110 may include a lighting source 114. Note, only one lighting source 114 is referenced for clarity. Further note, that although only three lighting sources are illustrated in FIG. 1 it is presumed that the base section 110 may include fewer or more lighting sources than illustrated. The lighting source 114 purpose and function is to illuminate environments that lack proper lighting for operating the jack system 100. The lighting source 114 may be toggled using the mobile wireless device 104. In one or more embodiments, the pillar section 112 includes an alert system 116. The alert system 116 may be coupled to a processor (described in connection with FIG. 2). The alert system 116 is a series of lights, that may include sounds, that are activated in a pattern or distinguishable colors to alert the individual of potential hazards. For example, the alert system 116 may have a light pattern of green, yellow, and red wherein the green indicates that the jack system 100 is operating safely. A yellow indicator light may communicate that the jack system 100 has the potential of shifting or buckling under the load of the vehicle; and a red indicator light may communicate that the jack system 100 is failing or has failed to operate effectively. Although the alert system 116 is illustrated in FIG. 1 as a series of lights, the alert system 116 may include a combination of lights and sounds emitting from the jack system 100.

Safety is an important feature of this apparatus. For example, FIG. 2. is a profile view of a pantograph jack system illustrating safety embodiments encased in a platform of a pantograph jack system. As illustrated in FIG. 2, the base section 110 may include a processor 118. The processor 118 is an integrated electronic circuit that performs the calculations that run a computer-more specifically, runs the jack system 100. A processor performs arithmetical, logical, input/output and other basic instructions that are passed from an operating system-such as from the mobile wireless device 104. That is, the processor 118 is communicably coupled to the mobile wireless device 104.

Another safety feature that may be included in the base section 110 is an accelerometer tilt sensor 120. An accelerometer tilt sensor is a device used for measuring the tilt or rotation of an object in multiple axes with reference to an absolute level plane. The tilt sensors have the ability to alter obtained physical acceleration from motion or gravity into a voltage output. The purpose of the accelerometer tilt sensor 120 is to recognize when the jack system 100 is rotating off balance because of improper use and will respond by quickly by deactivating the jack system 100 so that any potential injuries can be avoided. The accelerometer tilt sensor 120 is coupled to the processor 118, and thus is able to communicate alerts to the alert system 116 and to the wireless mobile device 104.

In one or more embodiments, as illustrated in FIG. 2, the base section 110 includes a pressure sensor 122 coupled to the processor 118. The pressure sensor 122 is a measurement tool for detecting, monitoring, reading, and displaying changes in applied pressure from a contained volume of liquid or gas. These devices can also be used with uncontained volumes, such as atmospheric pressure. The pressure sensor 122, as illustrated, is positioned under a center-axis of the pantograph jack 102 to ensure accuracy of the pressure created by the weight load of a vehicle. Having the pressure sensor 122 coupled to the processor 118 also allows the processor 118 to read data from the pressure sensor 122 and transmit that information to the alert system 116 and to the wireless mobile device 104.

To further measure the pressure applied to the jack system 100, the jack system 100 may include a strain detection system 124 coupled to the processor 118. The strain detection system 124, also known as a strain gauge, is a sensor whose resistance varies with applied force. It converts force, pressure, tension, weight, etc., into a change in electrical resistance which can then be measured. The measurements read by the processor 118 and received from the strain detection system 124, the pressure sensor 122, and the accelerometer tilt sensor 120 allows the processor 118 to quickly analyze the data and determine if failure is about to occur. Any potential failure notice can be transferred from the jack system 100 via a short-wave wireless receiver 126 coupled to the processor 118 and delivered to the mobile wireless device 104. As described above, a short-wave wireless receiver 126 commonly known as BLUETHOOTH® (owned by BLUETOOH SIG, INC.), is a short-range wireless technology standard that is used for exchanging data between fixed and mobile devices over short distances and building personal area networks.

The mechanical operation of the jack system 100 may be performed by a motor 128. As illustrated in FIG. 2, the motor 128 is mechanically coupled to the pantograph jack 102 and electronically coupled to the processor 118. The motor 128 may be a six-, twelve-, or twenty-four-volt direct current motor. In one or more embodiment, the motor 128 may include a rechargeable battery for situations in which auxiliary power is unavailable. When activated, the motor 128 engages the pantograph jack 102 to either extend upwards or descend downwards (i.e., raise or lower the pantograph arms).

In one or more embodiments, the jack system 100 includes a slippage control 130. Specifically, the motor 128 may include the slippage control 130. Slippage control as defined herein refers to a feature or mechanism designed to prevent or minimize unintended movement or slipping of the jack system 100 during operation. This is particularly important to ensure stability and safety during the lifting and lowering of vehicles. Slippage control mechanisms can include features such as a slip-resistant base, rubberized pads, or other means to enhance traction and prevent the jack from sliding or tipping, especially when used on uneven surfaces or in challenging conditions. The goal is to provide a secure and stable foundation for the jack, reducing the risk of accidents and ensuring reliable performance. Here, the slippage control 130 is coupled to the motor 128 to determine if slippage will occur during the rotation of the rod arm of the pantograph jack 102.

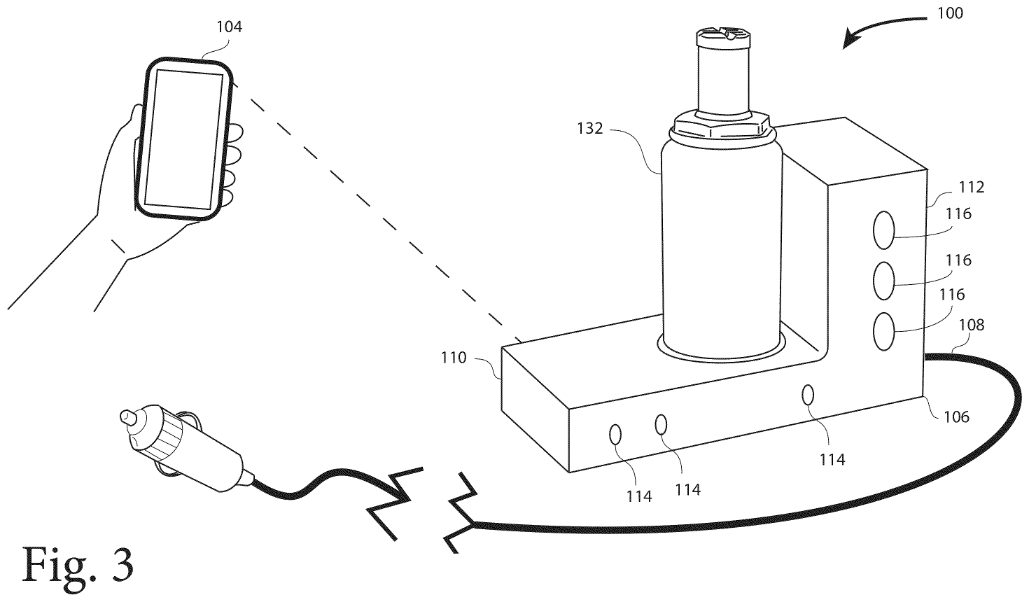

In one or more embodiments, the jack system 100 may be designed in different variations. For example, FIG. 3 is a perspective view of a jack system comprising a bottle jack and a wireless mobile device. Here, as illustrated, the jack system 100 may include a bottle jack 132. Although serving the same function as the pantograph jack 102, the bottle jack 132 are devices that are a type of hydraulic jack used for lifting heaving loads, such as vehicles. These devices feature a tall, vertical cylinder with a wide base and a lifting platform on top that can be raised or lowered using a hydraulic pump. The lifting mechanism is typically powered by a hydraulic system that uses pressure to move a piston inside the cylinder, which in turn raises the platform.

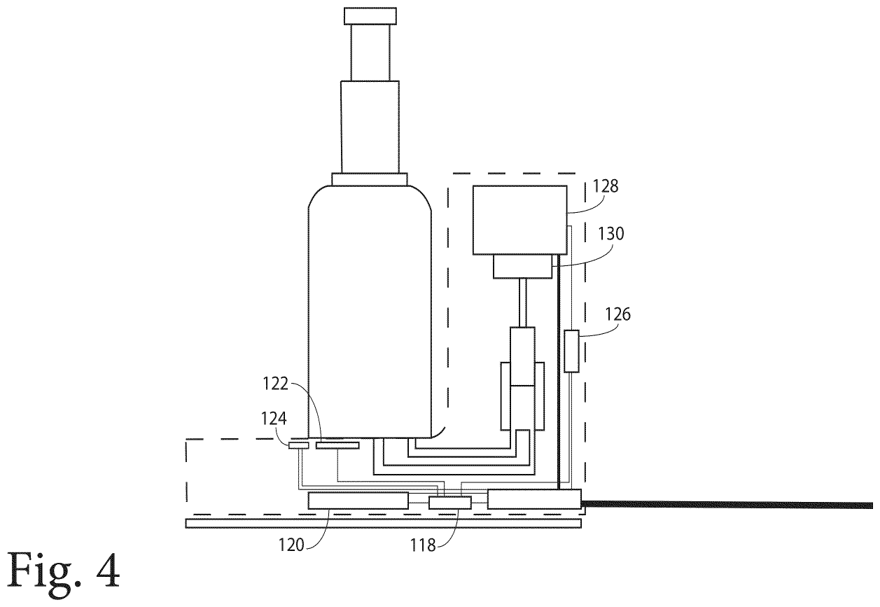

Similar to the pantograph jack 102 described in connection with FIGS. 1-2, the bottle jack 132 illustrated in FIG. 3 may include all of the features and safety elements as those described in FIGS. 1-2. For example, the bottle jack 132 may include the mobile wireless device 104, the platform 106, the retractable power adaptor 108, the base section 110, a pillar section 112, a base lighting source 114, and an alert system 116. In addition, FIG. 4 is a profile view of a bottle jack system illustrating safety embodiments encased in a platform of a bottle jack system. Here, the same safety features and embodiments described in connection to FIGS. 1 and 2 are also applicable and similar to those illustrated in FIGS. 3 and 4. For example, the bottle jack 132 may also include the processor 118, the accelerometer tilt sensor 120, pressure sensor 122, strain detection system 124, short-wave wireless receiver 126, the motor 128, and the slippage control 130. However, the bottle jack 132 is powered by the motor 128 that mechanically engages the bottle jack 132 hydraulic system to engage the piston and thus lifting the vehicle. The hydraulic system is electronically coupled to the processor 118 through a monitoring device that sends data to the processor 118. Although not illustrated, a valve system is coupled to the processor 118 so the individual can release the fluid from the hydraulic system using the mobile wireless device 104.

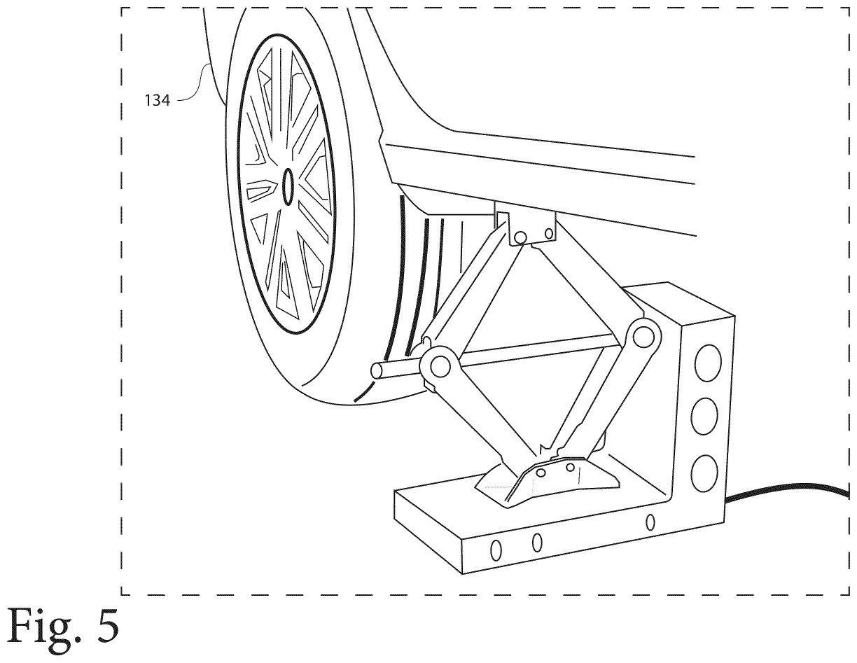

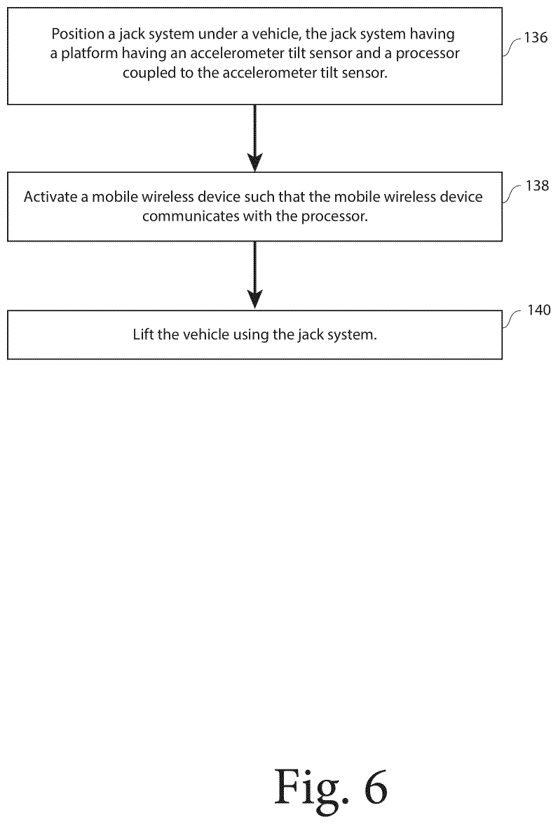

In operation, as illustrated in FIG. 5, the jack system 100 is typically used to lift a vehicle 134, or other similar apparatus. Note, FIG. 5 is a perspective view of a pantograph jack system positioned under a mobile vehicle. The method by which the jack system 100 is operated is illustrated in FIG. 6, which is a flow chart of the method of using a jack system. For example, a jack system (such as jack system 100) is positioned under a vehicle (such as vehicle 134). The jack system (such as jack system 100) has an accelerometer tilt sensor (such as accelerometer tilt sensor 120) and a processor (such as processor 118) couped to the accelerometer tilt sensor (such as accelerometer tilt sensor 120) (block 136). A mobile wireless device (such as mobile wireless device 104) is activated such that the mobile wireless device (such as mobile wireless device 104) communicates with the processor (such as a processor 118) (block 138). The vehicle (such as vehicle 134) is lifted using the jack system (such as jack system 100) (block 140).

In one aspect, an apparatus includes a jack system coupled to a platform. The platform has a base section having an accelerometer tilt sensor, a pressure sensor, and a processor coupled to the accelerometer tilt sensor and to the pressure sensor. A pillar section is integrally coupled to the base section.

Implementation may include one or more of the following. The jack system may include a pantograph jack. The pillar section may include a motor mechanically coupled to the pantograph jack system and electronically coupled to the processor. The jack system may include a bottle jack. The platform may include a hydraulic system mechanically coupled to the bottle jack system and electronically coupled to the processor. The pillar may include a strain detection system coupled to the processor. A short-wave wireless receiver may be coupled to the processor. A mobile wireless device may be communicably coupled to the short-wave wireless receiver such that when connected to the short-wave wireless receiver the mobile wireless device communicates with the processor. An alert system may be coupled to the processor. The platform may include a retractable power adaptor. The platform may include a slippage control.

In one aspect, a method includes positioning a jack system under a vehicle. The jack system has a platform. The platform has a base section having an accelerometer tilt sensor, a pressure sensor, and a processor coupled to the accelerometer tilt sensor and to the pressure sensor. A pillar section is integrally and adjacently coupled to the base section. A mobile wireless device is activated such that the mobile wireless device communicates with the processor. The vehicle lifts the jack system.

Implementation may include one or more of the following. The jack system may include a pantograph jack. The pillar section may include a motor mechanically coupled to the pantograph jack system and electronically coupled to the processor. The jack system may include a bottle jack. The platform may include a hydraulic system mechanically coupled to the bottle jack system and electronically coupled to the processor. The pillar may include a strain detection system coupled to the processor. A short-wave wireless receiver may be coupled to the processor. A mobile wireless device may be communicably coupled to the short-wave wireless receiver such that when connected to the short-wave wireless receiver the mobile wireless device communicates with the processor. An alert system may be coupled to the processor. The platform may include a retractable power adaptor. The platform may include a slippage control.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus comprising:
a jack system coupled to a platform, the platform having:
a base section having:
an accelerometer tilt sensor;
a pressure sensor;
a processor coupled to the accelerometer tilt sensor and to the pressure sensor; and
a pillar section integrally and adjacently coupled to the base section.

2. The apparatus of claim 1 wherein the jack system comprises a pantograph jack.

3. The apparatus of claim 2 wherein the pillar section comprises a motor mechanically coupled to the pantograph jack system and electronically coupled to the processor.

4. The apparatus of claim 1 wherein the jack system comprises a bottle jack.

5. The apparatus of claim 4 wherein the platform comprises a hydraulic system mechanically coupled to the bottle jack system and electronically coupled to the processor.

6. The apparatus of claim 1 wherein the pillar includes a strain detection system coupled to the processor.

7. The apparatus of claim 1 further comprising a short-wave wireless receiver coupled to the processor.

8. The apparatus of claim 7 comprising a mobile wireless device communicably coupled to the short-wave wireless receiver, such that when connected to the short-wave wireless receiver the mobile wireless device communicates with the processor.

9. The apparatus of claim 1 further comprising an alert system coupled to the processor.

10. The apparatus of claim 1 wherein the platform has a retractable power adaptor.

11. The apparatus of claim 1 wherein the platform further comprises a slippage control.

12. A method comprising:
positioning a jack system under a vehicle, the jack system having:
a platform having:
a base section having:
an accelerometer tilt sensor,
a pressure sensor;
a processor coupled to the accelerometer tilt sensor and to the pressure sensor; and
a pillar section integrally and adjacently coupled to the base section;
activating a mobile wireless device such that the mobile wireless device communicates with the processor; and
lifting the vehicle using the jack system.

13. The apparatus of claim 12 wherein the jack system comprises a pantograph jack.

14. The apparatus of claim 12 wherein the pillar section comprises a motor mechanically coupled to the pantograph jack system and electronically coupled to the processor.

15. The apparatus of claim 12 wherein the jack system comprises a bottle jack.

16. The apparatus of claim 15 wherein the platform comprises a hydraulic system mechanically coupled to the bottle jack system and electronically coupled to the processor.

17. The apparatus of claim 12 wherein the pillar includes a strain detection system coupled to the processor.

18. The apparatus of claim 12 further comprising a short-wave wireless receiver coupled to the processor.

19. The apparatus of claim 18 comprising a mobile wireless device communicably coupled to the short-wave wireless receiver, such that when connected to the short-wave wireless receiver the mobile wireless device communicates with the processor.

20. The apparatus of claim 12 further comprising an alert system coupled to the processor.

21. The apparatus of claim 12 wherein the platform has a retractable power adaptor.

22. The apparatus of claim 12 wherein the platform further comprises a slippage control.
